(19) United States
(12) Patent Application Publication
(10) Pub. No.: US 2008/0228647 A1
(43) Pub. Date: Sep. 18, 2008

(54) Method and computer-readable medium for managing an account balance

(75) Inventors: Ted Kachel, Purchase, NY (US); John Orem, Oklahoma City, OK (US); Ted Growe, Piedmont, OK (US); Blaine Trimmell, Edmond, OK (US); Deborah Miller, Moore, OK (US); Brian Fredrickson, Oklahoma City, OK (US)

Correspondence Address: CROWELL & MORING LLP;INTELLECTUAL PROPERTY GROUP, P.O. BOX 14300, WASHINGTON, DC, 20044-4300, US

(73) Assignee: Axiom Automotive Technologies, Inc., Pittsburgh, PA (US)

(21) Appl. No.: 11/723,162

(22) Filed: Mar. 16, 2007

(51) Int. Cl. G06Q 40/00

(52) U.S. Cl. 705/42

(57) ABSTRACT

A method and computer-readable medium for managing an account balance of a user via remote connection to an account database system of a service provider are provided. According to the method, payment information is received from the user via the remote connection for a selected invoice of an account of the user. The payment information is outputted to an external payment service for settlement of payment, and, if the settlement is successful, authorization and settlement data are received from the external payment service and written to a payment file of the user. A transaction record is then written to an account transactions file of the service provider, thereby triggering execution of an accounting program for posting the authorization and settlement data to the user's account and to financial records of the service provider. The updated invoice information may then be outputted to the user.

### BACKGROUND OF THE INVENTION

The present invention relates to a method and computer-readable medium for managing an account balance. More specifically, the present invention relates to a method and computer-readable medium for allowing a user to manage an account balance remotely, e.g., via the Internet, by triggering a database function.

Currently, users must either call a company's customer service representative and provide payment information over the telephone or send payments via mail to make payments on their account balances. The user tells a customer service personnel which invoices and how much to pay. The customer service personnel then contacts an external payment service organization to process the payment and enters the payment information into the company's accounting system. This is a labor intensive process, requiring a significant amount of time and numbers of employees for the company to process the payments.

### SUMMARY OF THE INVENTION

The present invention allows an authorized user to access a company's account balance database through an Internet web page for review and payment processing, i.e., a “self-service” process for users to make payments to their accounts. By selecting specific invoices and entering credit card or other payment information, the authorized user can make payments to his account.

According to the present invention, the payment transaction is processed without intervention by the company, and the payment is recorded in both the accounts receivable detail records and the company's financial information. The Internet web page may be used to trigger execution of an accounting software program to accomplish the payment and update of records.

Other objects, advantages, and novel features of the present invention will become apparent from the following detailed description of the invention when considered in conjunction with the accompanying drawings.

### BRIEF DESCRIPTION OF THE DRAWINGS

FIG. 1 illustrates an exemplary embodiment of a system for managing an account balance in accordance with the present invention; and

FIGS. 2A and 2B illustrate an exemplary embodiment of a method for managing an account balance in accordance with the present invention.

### DETAILED DESCRIPTION OF THE EXEMPLARY EMBODIMENTS

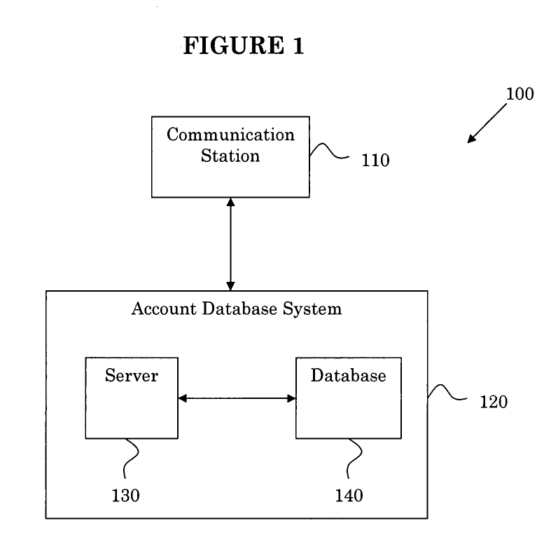

FIG. 1 illustrates an exemplary embodiment of a system for managing an account balance in accordance with the present invention. As illustrated in FIG. 1, the system 100 includes a communication station 110, which may be a computer, PDA, etc., which provides a user interface. The communication station 110 may be connected to an account database system 120 of a company (service provider) via a remote connection, which may be an Internet connection, for example. The account database system 120 may include a server 130 and one or more databases 140. The server may be an AS 400 server, for example. A database program, such as DB2, may be used to access the data contained in the databases.

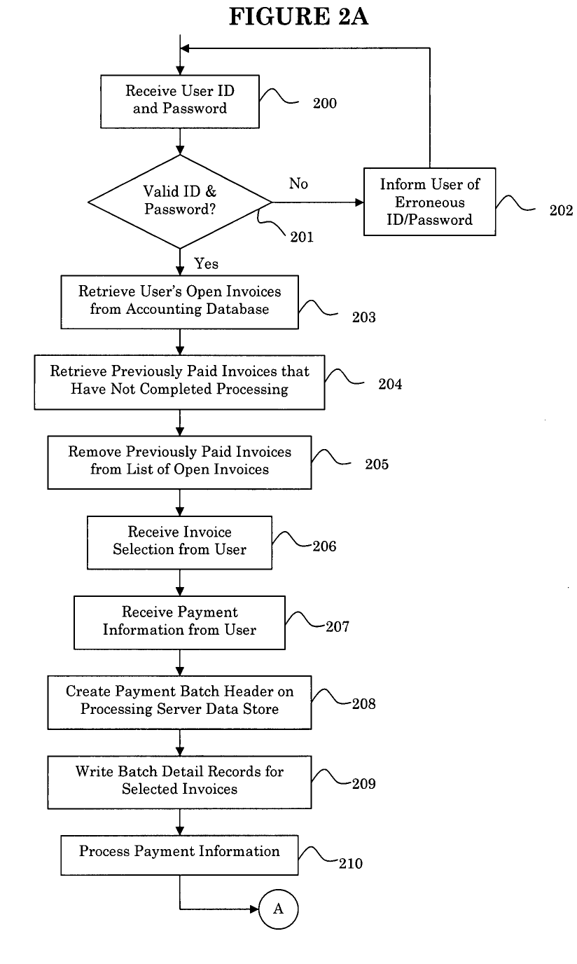

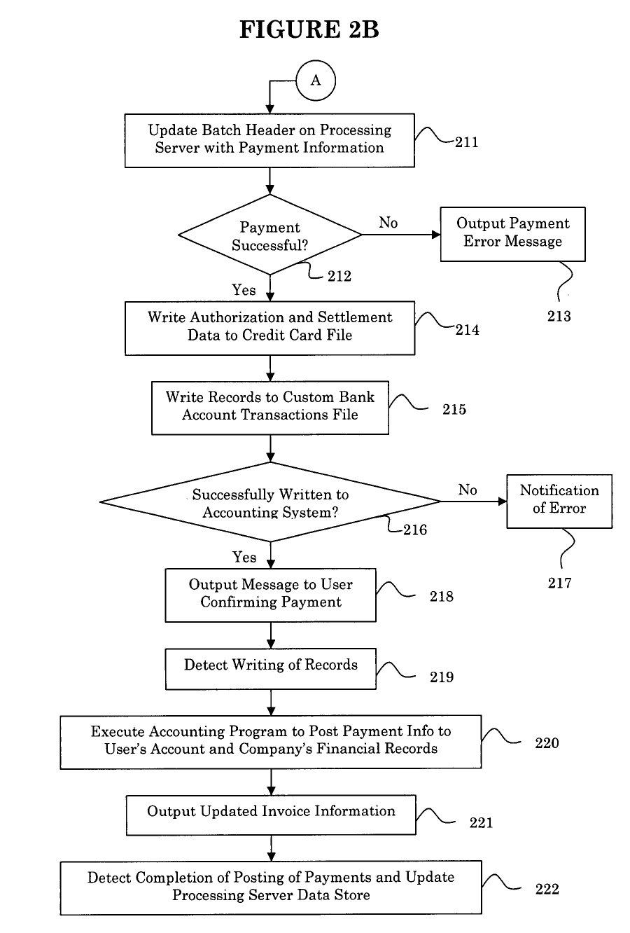

FIGS. 2A and 2B illustrate an exemplary embodiment of a method for managing an account balance in accordance with the present invention. A user may access the account database system 120 over the Internet via his communication station 110. After opening a payment web page of the service provider, the user may gain access to the account database system 120 by entering a user ID and password via the user interface of the communication station 110. The user ID and password are received in step 200. In step 201, a check is performed to determine whether the ID and password information are valid. If they are not valid, a message is sent to the user to inform him of the erroneous ID and/or password, at which point the user may again try to login to the system by re-entering the ID and password. If the ID and password are valid, the user is logged into the account database system 120.

Once logged into the account database system 120, the user may view his account(s) via web pages and choose to make a payment of an account balance. The account database system 120 may retrieve the user's open invoices from an accounting database in step 203. In step 204, invoices that have been previously paid, but have not completed processing in the account system, are retrieved. In step 205, the invoices retrieved in step 204 are removed from the list of open invoices that were retrieved in step 203, thereby removing any invoices that may have already been paid, but have not completed processing due to processing time and/or potential processing delays. In step 205, the list of open invoices that have not already been paid may be displayed to the user via web page. The web page may display invoice numbers, invoice dates, due dates, invoice amounts and amounts due, for example. The user selects one or more of the open invoices on which to make a payment, for example, by selecting a check box on the display via the user interface. The user's invoice selection is received in step 206.

The account database system 120 receives payment information from the user in step 207 for making a payment to the selected invoice. The payment information may be credit card information, e.g., card number, expiration date, etc. In step 208, a payment batch header record is written to a processing server data store, which can be a database on the web server. A batch ID may also be written to the processing server data store in step 208. In step 209, batch detail records are written to the processing server data store for the selected invoice(s). A batch detail record may be created for each invoice selected by the user.

In step 210, the payment information is processed. The processing of the payment information may include sending the payment information to an external payment service, e.g., Verisign Payment Services, for processing. In step 211, the batch header record is updated with the payment information for the payment transaction(s).

In step 212, it is determined whether the payment was successfully processed. If the payment processing was not successful, an error message may be outputted to the user in step 213 to inform the user that the payment could not be processed. If the payment was successfully processed, authorization and settlement data received from the external payment service, e.g., settlement number and settlement amount, may be written by the processing server to a payment file of the user in step 214. The payment file may be an accounting system electronic payment table, for example. In step 215, a record of the payment transaction may be written to an account transactions file in the account database system 120 of the service provider. For example, the transaction may be recorded in a header file and a detail file for accounts receivable and a general ledger system. The header file and the detail file may include, for example, the following information:

Header File

User ID

Payment/Item Number

Transaction Type

Address Number

Pay Status

Batch Number

Check/Item Date

G/1 Date

Settlement Number

Settlement Amount

Date Updated

Time Last Updated

Variable Return Data

Description

Detail File

Payment/Item Number

Transaction Type

Document Number

Document Type

Pay Item

Company

Invoice Date

Payment Terms

Mode

Gross Amount

Pay Status

Date Updated

Time Last Updated

In step 216, it is determined whether the header and detail information of the payment transaction have been successfully written to the accounting system. If the information has not been successfully written, a notification, such as an e-mail, may be sent in step 217 to a company personnel that the payment was not properly communicated to the accounting system and will need to be completed manually. If the information was successfully written to the accounting system, a message may be outputted to the user in step 218 confirming the payment. The message may be sent by e-mail, for example.

The writing of the records into the account transactions file may be detected in step 219. The writing of the record may trigger the execution of an accounting program for posting the authorization and settlement data to the user's account and to financial records of the service provider in step 220. The accounting program may be a JD Edwards accounting program, for example. Accordingly, the selected invoice is updated to reflect the payment. In step 221, the accounting program updates the custom transaction table and outputs the updated invoice information to the user. In step 222, the processing server detects posting of payments completed and updates the processing server data store, i.e., the batch header record created in step 208, based on the completed payments.

In an exemplary embodiment of the present invention, a DB2 database trigger executes the accounting program, which may include the following steps. The transaction may be assigned a cash receipts batch number, and a batch header record may be created. A header payment record may be read from the header file. Until all detail records have been processed, the following steps may occur: Obtain detail payment records from the detail file, Obtain open invoice record from accounting program detail file, Verify that the payment detail record and the open invoice record match, Write records to a file, Execute an accounts receivable batch cash application program, and Update detail payment record with batch number. The accounts receivable batch cash application program may update the user's accounts receivable records, create a general ledger accounting records, and create audit reports. After all detail records have been processed, the header payment record is updated with a batch number, and an accounting program is executed to post cash receipts batch.

In another exemplary embodiment of the present invention, there is a computer-readable medium encoded with a computer program for managing an account balance of a user via remote connection to an account database system of a service provider. The term “computer-readable medium” as used herein refers to any medium that participates in providing instructions for execution. Such a medium may take many forms, including but not limited to, non-volatile media, volatile media, and transmission media. Non-volatile media includes, for example, optical or magnetic disks. Volatile media includes, for example, dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave, or any other medium from which a computer can read.

An exemplary embodiment of a computer-readable medium encoded with a computer program for managing an account balance of a user via remote connection to an account database system of a service provider is illustrated in FIGS. 2A and 2B, which are described above.

While the invention has been described in connection with various embodiments, it will be understood that the invention is capable of further modifications. This application is intended to cover any variations, uses or adaptation of the invention following, in general, the principles of the invention, and including such departures from the present disclosure as, within the known and customary practice within the art to which the invention pertains.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for managing an account balance of a user via remote connection to an account database system of a service provider, comprising the acts of:
receiving authorization and settlement data for a payment transaction initiated by the user;
detecting a trigger event in the account database system, indicating that the payment transaction has been successfully processed; and
executing an accounting program for posting the authorization and settlement data to an account of the user and to financial records of the service provider.

2. The method of claim 1, wherein the trigger event triggers a DB2 function.

3. The method of claim 1, wherein the trigger event comprises writing a transaction record to an account transactions file of the service provider.

4. The method of claim 1, further comprising the act of:
receiving payment information from the user for a selected invoice of the account of the user via the remote connection.

5. The method of claim 4, further comprising the act of:
outputting the payment information to an external payment service for settlement of payment.

6. The method of claim 1, wherein the authorization and settlement data is received from an external payment service.

7. The method of claim 1, further comprising the act of:
displaying updated account information to the user after the accounting program is executed.

8. The method of claim 1, wherein posting the authorization and settlement data comprises recording the authorization and settlement data in a header file and a detail file.

9. The method of claim 1, wherein the remote connection comprises an Internet connection.

10. A method for managing an account balance of a user via remote connection to an account database system of a service provider, comprising the acts of:
receiving payment information from the user for a selected invoice of an account of the user via the remote connection;
outputting the payment information to an external payment service for settlement of payment;
receiving authorization and settlement data from the external payment service and writing the authorization and settlement data to a payment file of the user;
writing a transaction record to an account transactions file of the service provider, thereby triggering execution of an accounting program for posting the authorization and settlement data to the user's account and to financial records of the service provider; and
outputting updated invoice information to the user, after execution of the accounting program.

11. The method of claim 10, wherein triggering execution of the accounting program comprises triggering a DB2 function.

12. The method of claim 10, wherein the payment information comprises a credit card number of the user.

13. The method of claim 10, further comprising the act of:
determining validity of the payment information.

14. The method of claim 13, further comprising the act of:
outputting an error message, if the payment information is invalid.

15. The method of claim 10, further comprising the acts of:
receiving login information of the user via the remote connection; and
retrieving information of one or more active invoices of the user from a database, based upon the login information.

16. A computer-readable medium encoded with a program for managing an account balance of a user via remote connection to an account database system of a service provider, the program comprising instructions for:
receiving authorization and settlement data for a payment transaction initiated by the user;
detecting a trigger event in the account database system, indicating that the payment transaction has been successfully processed; and
executing an accounting program for posting the authorization and settlement data to an account of the user and to financial records of the service provider.

17. The computer-readable medium of claim 16, wherein the trigger event comprises writing a transaction record to an account transactions file of the service provider.

18. The computer-readable medium of claim 16, further comprising instructions for:
receiving payment information from the user for a selected invoice of the account of the user via the remote connection.

19. The computer-readable medium of claim 16, further comprising instructions for:
outputting the payment information to an external payment service for settlement of payment.

20. The computer-readable medium of claim 16, wherein the authorization and settlement data is received from an external payment service.

21. The computer-readable medium of claim 16, further comprising instructions for:
displaying updated account information to the user after the accounting program is executed.
